(19) United States
(12) Patent Application Publication
(10) Pub. No.: US 2003/0139901 A1
(43) Pub. Date: Jul. 24, 2003

(54) Navigating organizational structures

(76) Inventors: George Henry Forman, Port Orchard, WA (US); Henri Jacques Suermondt, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/054,029

(22) Filed: Jan. 22, 2002

(51) Int. Cl. G06F 17/18

(52) U.S. Cl. 702/179

(57) ABSTRACT

In prediction and machine-learning technology, using given information from a user and a set of choices (e.g., a hierarchy structure) and, using a classifier program, computing what is the next best choice for navigating the set of choices, or, more generally, the degree to which any choice at a current level is supported by the available information, i.e., a probability of success associated with each currently available choice. An interactive interface is provided between the user and the set owner that dynamically feeds back the results of classification to the user preferably at each navigation step, i.e., specifying probabilities, suggesting choices, or highlighting the best choice(s) or the path(s) most likely leading to the best ultimate choice of the set.

### (2) CROSS-REFERENCE TO RELATED APPLICATIONS

Not Applicable.

### (3) STATEMENT REGARDING FEDERALLY SPONSORED RESEARCH OR DEVELOPMENT

Not Applicable.

### (4) REFERENCE TO AN APPENDIX

Not Applicable.

### (5) BACKGROUND

(5.1) Field of Technology

The present invention relates generally to topical decision algorithms and structures.

(5.2) Description of Related Art

In the past, many different systems of organization have been developed for categorizing different types of items. Such systems can be used for organizing almost anything, from material items (e.g., different types of screws to be organized into storage bins, books to be stored in an intuitive arrangement in a library, viz. the Dewey Decimal System, and the like) to the more recent need inspired by the computer and Internet revolution for organized categorization of knowledge items (e.g., informational documents, book content, visual images, and the like). Many known forms of electronic organizational structures, such as graphs, structures generally referred to in the art as hierarchical structures, or more simply hierarchies, and the like, have been developed. The larger the hierarchy, the more complicated become the options which users can select from. As selection options grow, the harder it gets for users to make the next choice for working through the hierarchy structure to reach a desired target.

A simple example of an Internet hierarchy structure which allows searching by the user is a website homepage (e.g., www.hp.com, www.yahoo.com, or the like) where links are provided whereby the user may step through the website. Another example of a large hierarchy would be a customer support site where cases have to be assigned by domain experts to a location in a hierarchy of products, or where a call qualifier has to decide to whom to dispatch it. Another application is where an electronic mail (hereinafter “e-mail”) message is received and e-mail qualifier has to decide where to forward it. As another more specific example, on the Internet there is a site for the Universal Description, Discovery and Integration of Business for the Web (www.uddi.org). The UDDI project goal is to create a registry for any type and size of business wherein the registry is a platform-independent, open framework for describing services, discovering businesses, and integrating business services. The organizational structure includes a plurality of hierarchies, intended to enable users to quickly and dynamically find registered businesses in any field. Both in registering a new business and in finding a registered business suitable for specific commerce goals, the users wind their way (generally “point-and-click” or enter specific keyword searches) through the UDDI hierarchical maze (note, implementations of the present invention can be applied to any large hierarchy, e.g., tree structures, Web address cross-links, and the like, depending on the specific implementation).

Methods and technology, known as classifiers, exist for automatically assigning items to categories in a hierarchy. Many known automated forms of hierarchical organization classifiers have been developed, e.g., rule-based assignment, multi-category flat categorization (such as using Naive Bayes or C4.5 algorithms), level-by-level hill-climbing categorization (also known as “Pachinko machine” categorization), and level-by-level probabilistic categorization. Some of these are forms of machine learning in that the methods can improve in accuracy using examples of items for which the correct category is known. Classification technology such as this is being used to create and maintain computer-based hierarchies in that it can be used to automatically identify the category that, based on the description of the item, forms the most appropriate location for it. Such classifier products and services for automating organization of unstructured information in digital domains are available commercially, for example from Autonomy Inc., having a place of business in San Francisco, Calif. A user may need to navigate a hierarchy not to place an item in it, but rather to see what other items are in a category. When searching a large hierarchy, the user may have a description of the type of information contained in the category they are looking for, without knowing where this category is in the hierarchy or even whether there are multiple categories that match their information needs. The name or description of a branch in a hierarchy is usually terse and may not be highly indicative of the items contained in such a branch, especially not of the sub-branches contained underneath it. In that case, the user needs assistance as to which path is likely to lead to a category that matches their information needs.

Two problems of searching a large hierarchy are: (1) which path is the next best path toward a desired target, and (2) what is the next best refinement of the search query based on the current hierarchy node selection. Prediction technology (e.g., machine-learning (a branch of artificial intelligence technology), classification/categorization, and the like) is being used to create and maintain computer-based hierarchies. “Classifier” products and services for automating operation of unstructured information in digital domains, i.e., for automating hierarchy structures, are available commercially, such as from Autonomy, Inc. company, having a place of business in San Francisco, Calif. Machine-learning in the nature of a classifier program allows for automated recognition of common data patterns and content—usually based on known data pattern or content training cases, e.g., where it is known that such-and-such a labeled data pattern (e.g., words of an informational document, medical symptoms of known diseases, and the like) is probabilistically indicative of such-and-such a topic—in order to classify each new data set added thereafter into the hierarchy (or other organizational structure). Thus fundamentally, via training, the classifier becomes an automated decision maker as to where in the structure new input is to be placed. However, as the number of choices—particularly among the currently available choices of the hierarchy structure—grows, prediction technologies degrade in their ability to make good proposals for the next likely choice.

Unassisted hierarchical navigation of choices leaves the user primarily with persistence and luck, using their own inductive reasoning to step through the structure. Unless the usual terse labels for branches of the structure are perceived well, the user can easily get lost and frustrated. Multiple steps, accompanied by several false path searches, generally may be required to drill-down through large hierarchies.

Some website hierarchies are based on popularity of topics and subtopics rather than by a calculated, directed personalization of the user's goal or specific information provided by the user. Again, searches are generally difficult due to many optional paths that are provided.

Some software solutions (e.g., WordPerfect™, WORD 2000™) provide a short list for previously used menu items; once a particular item has been used, it is brought more or less to the foreground. This however is not a true classification of available information in a directory structure and does not dynamically adjust itself as more information becomes available during a particular search down a menu tree.

There is a need for an advanced methodology and tool which helps the user in making choices while navigating through a large hierarchy, e.g., whether to place a new item into it or to find the relevant category or categories where desired items may be found. Moreover, a proper solution should also benefit those working in creating, maintaining, and running a computerized hierarchy-dependent site using a classifier by directing attention to fewer and more accurate selection options. A proper solution should be interactive between the user and automated classifier(s) employed, dynamically guiding the user towards the selection of the targeted category and desired results (target goal).

### (6) BRIEF SUMMARY

In its basic aspect, embodiments of the present invention relate generally to topical decision algorithms. Some implementations relate more particularly to organizational structures such as hierarchical arrangement systems, and some specifically to a methodology and tool for assisting users in selection from large hierarchies via classification, particularly in computerized large hierarchy applications. In prediction and machine-learning technology, using given information from a user and a set of choices (e.g., a hierarchy structure) and, using a classifier program, computing what is the next best choice for navigating the set of choices, or, more generally, the degree to which any choice at a current level is supported by the available information, i.e., a probability of success associated with each currently available choice. An interactive interface is provided between the user and the set owner that dynamically feeds back the results of classification to the user preferably at each navigation step, i.e., specifying probabilities, suggesting choices, or highlighting the best choice(s) or the path(s) most likely leading to the best ultimate choice of the set.

The foregoing summary is not intended to be an inclusive list of all the aspects, objects, advantages and features of the embodiments of the present invention nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches. Objects, features and advantages of the embodiments of the present invention will become apparent upon consideration of the following explanation and the accompanying drawings, in which like reference designations represent like features throughout the drawings.

### (7) BRIEF DESCRIPTION OF THE DRAWING

FIG. 1 is a flowchart of a large hierarchy search process in accordance with embodiments of the present invention.

### (8) DETAILED DESCRIPTION

Reference is made now in detail to embodiments of the present invention which illustrate the best mode presently contemplated for practicing the invention. Alternative embodiments are also briefly described as applicable.

Prediction technology may be used to bring the most likely choices to the fore for easy selection (e.g., via on-screen highlighting, probability of correctness, defaults, and the like). The embodiments of the present invention are implementable as a computer program. The embodiments of the present invention relate to an interactive classifier methodology and tool, using feedback from the classifier to the user—namely, a user interface expressing the results of the classifier to make “better” choices more prominent. Moreover, automated updating of the classification as the user starts to go down a particular hierarchy path is implemented.

Basically, a classifier is employed at each decision node of the large hierarchy structure to recommend the best probable options for the next step to be taken for the user; one or more of the known manner classifier processes described in the Background section hereinabove may be adapted for use in accordance with certain process steps and associated programming of the embodiments of the present invention as described hereinbelow.

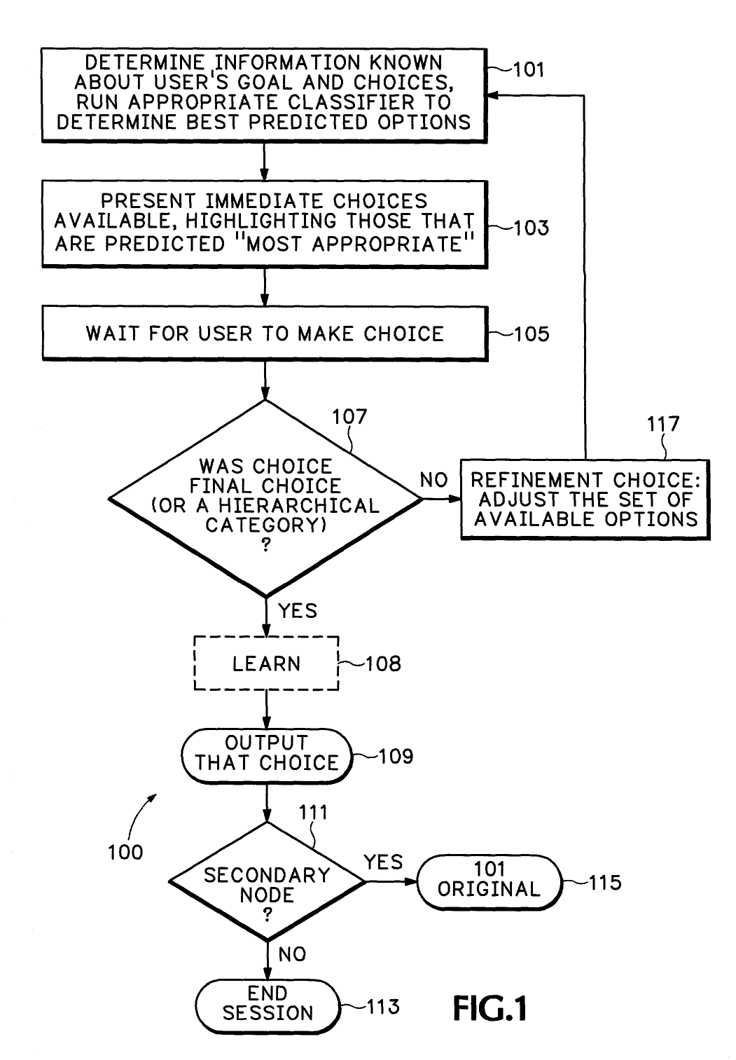

FIG. 1 is a flowchart of a large hierarchy search process in accordance with an implementation of the present invention. A UDDI hierarchy example will be employed for the purpose of explanation of this implementation; no limitation on the scope of the invention is intended nor should any be implied therefrom.

Assume a corporate information technology manager (“ITM”) for “ABC Inc.” has been authorized to register the corporations business at the UDDI website in an among at least one of the hierarchies available there. Thus, there is a collection of choices, organized in some form of large hierarchical structures, each having specific nodes therein. The ITM provides whatever information data is applicable to the business (e.g., name, type of business, address, telecommunication contact information, and the like), referred to hereinafter as “given information.” This starter set of data can be any form of personalization data and include any available information. In the exemplary implementation for case classification it includes the particular case to be assigned somewhere in a hierarchy. However, it can simply be based on the user's identity, previous usage patterns, or aggregate analysis of the user and other users.

A known manner classifier (or the like proprietary mechanism for comparing; see Background) is employed to examine the given information with respect to the collection of choices available at this top level and to determine the best predicted options for the next best options available, step 101. More specifically, the ITM wants to know the options for placing ABC into the hierarchy, but also of all the options available, which are the best choices to reach a node where other similar businesses are to be found, i.e., most likely particular path(s) (note that multiple hierarchy location listings for each business may be possible and desirable) that future users searching for such a business will follow (e.g., to the ITM, the target is to determine what is the most likely correct answer to the information related to the user's navigation goal, associated with reaching the “right” goal node, or what is the probability associated with each potential choice that it is a good place to place ABC, or the like probabilistically correct location in the structure for ABC). Note that other types of classifiers may be employed depending on the organization structure(s) being analyzed in any specific implementation.

The top level classifier presents, step 103, then interactively provides back to the ITM labeled choices, namely identifying the next level nodes of the UDDI hierarchy structure (e.g., in a hierarchy tree-form structure symbology, also known as “branches”) that are available to continue towards an appropriate node(s) where ABC's link should be stored. Most importantly, the choices are “highlighted” in some fashion which will indicate to the ITM which paths have the highest probabilities of reaching the appropriate final node(s). The “highlighting” can take the form of stated probabilities—e.g., “path A 95%, path B 82%, etc.”, simple color coding (preferred in color video monitor implementations) or the like—along with a label that is sufficient to identify each path (e.g., “path A=retail sales,” “path B=discount retail sales,” “path C=wholesalers,” etc.). Optionally, if sub-choice(s) can be predicted with good confidence from the given information (e.g., “retail sales ÷alcoholic beverages÷wine”), it can be listed as a shortcut choice, possibly allowing the ITM to accelerate the process. The processor then waits, step 105, for the ITM's reply, step 105.

Next, step 105, following receipt of the ITM's reply, a determination, step 107, is made as to whether the choice reflects a hierarchy terminus node (e.g., in a tree structure, a “leaf” node). In the alternative, the YES-path can also reflect the situation where the choice is an internal node in the hierarchy but is still a good place to place ABC and that no further refinement is needed.

If so (107, YES-path), the ITM is notified and ABC's link is stored at that UDDI hierarchy node (e.g., “wine and cheese specialty shops in Palo Alto Calif.”), step 109. Note that as part of this “final” choice step, the program can update its own algorithms (shown in phantom step 108,“LEARN”) having used the current session as a new “training example” for its data set. Note that this machine learning can occur at any or all input/output points of the process. In other words, the algorithm learns from each selection, making it a better, more precise predictor for the future. One means of accomplishing this is by redistributing the “eliminated” probability mass over the remaining branches. An alternative is to have a separately trained classifier for each sub-node in the hierarchy. The user interface is updated to reflect the newly available, more accurate, classification data. For example, if probabilities are shown, then after the user starts drilling down a particular path, the probability for that path goes to 100% and probabilities are shown for the next level down.

The process then queries whether the ITM wants to place ABC at other nodes of the hierarchy, step 111. If not (111, NO-path), the session is terminated, step 113. If so (111, YES-path), the session returns to the highest level, original search collection of choices, step 115, whereby the ITM can start over and at some point choosing a different branch.

If the ITM input does not reflect a hierarchy terminus node selection (107, NO-path), the ITM's input reflects a refinement choice. Therefore, having the given information and the new refinement choice input, the process can narrow the set of newly available options in view of the known hierarchy substructure subjacent the recently chosen branch path, viz., next branches and nodes, step 117. The classifier then repeats the analysis phase, looping to step 101. The process continues until a terminus node is achieved, 109.

Thus, “starter information,” that is, given both information from a user and a set of choices (ideally but not necessarily organized into a hierarchy such as a menu tree) and, using a classifier program, a recommendation is made as to what is the next best choice for navigating the set of choices, or, more generally, the degree to which any choice at a current level is supported by the available information, i.e., a probability of success associated with each currently available choice. An interactive interface is provided between the user and the set owner (e.g., an Internet web directory) that dynamically feeds back the results of classification to the user at each navigation step, i.e., specifying probabilities, suggesting choices, or highlighting the best choice(s) or the path(s) most likely leading to the best ultimate choice).

In one alternative embodiment, the user's selection of a particular branch can be interpreted by the classifier as a possibly a poor choice. That is, the classifier treats the selection of a branch as a possibly incorrect input. If there is overwhelming evidence that the proper category is elsewhere in the hierarchy, the classifier continues to highlight alternative branches not selected. This is helpful in poorly organized or ambiguous hierarchies where the top-level branches are not very indicative of the specific subcategories. A “smart look-ahead,” or “foresight,” feature can be implemented wherein based on the current “starter information,” likely choices are identified that are actually lower than currently available, next lower level, nodes of the structure. These identified foresight nodes can be presented for immediate consideration to the user in a known manner user interface format rather than waiting until the user drills down through the hierarchy to those nodes.

The foregoing description of embodiments of the present invention have been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. These embodiments were chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . ”

What is claimed is:

1. A tool for navigating an organizational structure having a plurality choices therein, including a plurality of next available choices, the tool comprising:
computer code means for receiving information related to a navigation goal wherein the goal is potentially related to at least one of the choices;
computer code means for classifying said information with respect to said structure and for providing a recommendation as to at least one of said choices more likely to lead towards said goal; and
computer code means for providing feedback indicative of said recommendation.

2. The tool as set forth in claim 1 further comprising:
computer code means for accessing at least one organizational structure of a plurality of available organization structures associated with said navigation goal.

3. The tool as set forth in claim 1 wherein the structure is a hierarchy.

4. The tool as set forth in claim 3 wherein said navigating is implemented as a search descending level-by-level through levels of the hierarchy.

5. The tool as set forth in claim 1 wherein said feedback is iterative, refining currently available choices in each iteration.

6. The tool as set forth in claim 1 comprising:
said computer code means for classifying is at least one classifier program related to a subset of choices of said plurality of choices.

7. The tool as set forth in claim 1, the computer code means for providing feedback indicative of said recommendation further comprising:
computer code means for recommending likely choices of said plurality of choices that are not said next available choices and for providing feedback indicative of likelihood of at least one suitable one of said likely choices as said goal.

8. The tool as set forth in claim 1 comprising:
computer code means for storing historical usage data, for learning from said historical usage data, and for improving said computer code means for classifying from said learning.

9. The tool as set forth in claim 1 wherein said computer code means for providing feedback indicative of said recommendation probabilistically facilitates navigation through the structure towards said navigation goal.

10. A computerized tool for assisting a user with navigating a large hierarchy structure, having a large plurality of nodes, via classification subprocesses, the tool comprising:
computer code for relating information indicative of a goal node to at least first level nodes of the hierarchy structure;
computer code for classifying said information and predicting at least one option most likely to advance navigation to a predicted goal node of said hierarchy structure;
computer code for highlighting said at least one option to said user;
computer code for receiving feedback from said user related to a current choice with respect to said at least one option; and
computer code for iteratively providing suggestions including at least one refined suggestion based on reclassifying said information each a current choice among said suggestions.

11. The tool as set forth in claim 10, said code for iteratively providing suggestions further comprising:
computer code for determining if said current choice is indicative of said goal node;
computer code for displaying to said user whether said current choice is said goal node; and
computer code for directing said user to said goal node if said choice is correct or otherwise for iteratively providing at least one refined option choice to said user based on reclassifying said information with a said current choice until said goal node is reached.

12. The tool as set forth in claim 10 further comprising:
computer code for analyzing said information and each said current choice and for storing data indicative of said analyzing such that later iterations of providing at least one refined option choice account for said data indicative of analyzing.

13. The tool as set forth in claim 10 wherein said computer code for highlighting is a graphical display highlighting at least one currently available choice of a plurality of currently available choices wherein said highlighting is indicative of a suggestion that said at least one currently available choice is more likely to achieve the goal node of said navigating.

14. The tool as set forth in claim 10 wherein said computer code for highlighting is a graphical display providing probability data for a plurality of currently available choices, said graphical display relating probability of each of said currently available choices toward achieving the goal node of said navigating.

15. The tool as set forth in claim 10 wherein said computer code for classifying said starter data set and predicting at least one option most likely to advance navigation to a probabilistically correct target goal node of said large plurality of nodes further comprises:
computer code for predicting at least one target goal node of said structure wherein said target goal node is a node being a sub-node one or more levels below other said currently available choices.

16. The tool as set forth in claim 10 in a computer memory device.

17. A process for navigating through an organizational structure having a plurality of levels and nodes, the method comprising:
receiving targeting data related to said organizational structure;
applying a classifier to said targeting data;
presenting a plurality of choices of nodes wherein said choices are representative of results of said classifier categorizing said targeting data with respect to said organizational structure and wherein said plurality of choices includes at least a subset of said plurality of choices indicating probable solutions to said targeting data;
receiving a selection from said plurality of choices;
iteratively applying the classifier to said targeting data and each said selection until a user target node is reached.

18. The process as set forth in claim 17 comprising:
receiving descriptions of a plurality of organizational structures, and
determining which organizational structure of said plurality is appropriate for use in said process by comparing said targeting data to said descriptions.

19. The process as set forth in claim 17 wherein presenting a plurality of choices of nodes comprises:
presenting a plurality of currently available next choices according to the next level of the organizational structure.

20. The process as set forth in claim 17 wherein presenting a plurality of choices of nodes comprises:
presenting a plurality of currently available next choices according to the next level of the organizational structure and a plurality of highly likely choices of potential user target nodes that lie below the said next choices.

21. The process as set forth in claim 17 wherein said presenting a plurality of choices of nodes comprises:
presenting only said subset.

22. The process as set forth in claim 17 further comprising:
for each said iteration, analyzing said targeting data and each said current choice and storing data indicative of said analyzing such that later iterations of presenting present only said subset accounting for said data indicative of analyzing.

23. The process as set forth in claim 17 wherein said presenting a plurality of choices of nodes further comprises:
displaying a graphical display highlighting at least one currently available choice of a plurality of currently available choices wherein said highlighting is indicative of highest probability of said at least one currently available choice being most likely to achieve the user target node of the structure.

24. The process as set forth in claim 17 wherein said presenting a plurality of choices of nodes further comprises:
displaying a graphical display providing probability data for a plurality of currently available choices, said graphical display relating probability of each of said currently available choices likelihood toward achieving the user target node of said structure.

25. A method of determining a goal node in an organizational structure having a plurality of nodes, the method comprising:
via a classifier, comparing first data indicative of a user goal node to second data indicative of given organizational structures;
selecting at least one of said structures and a plurality of nodes therein;
providing feedback data indicative of likely nodes related to said goal node such that at least one of said nodes is a target node predicted to be said goal node from a probabilistic analysis during said comparing, and wherein said feedback data allows selection between said likely nodes and said target node.

26. The method as set forth in claim 25 further comprising:
if said target node is selected, ending said comparing, and
if said target node is not selected and one of said likely nodes is selected, re-comparing said first data with said one of said likely nodes that is selected, and providing further feedback data indicating of likely subsidiary nodes to said likely node that is selected such that at least one of said likely subsidiary nodes is a target node predicted to be said goal node from a probabilistic analysis during said re-comparing, and wherein said feedback data allows selection between said likely subsidiary nodes and said target node.

27. A method of doing business, the method comprising:
receiving from a remote user targeting data related to at least one organizational structure having a plurality of levels and nodes;
applying a classifier to said targeting data;
presenting a plurality of choices of nodes to the remote user wherein said choices are representative of results of said classifier categorizing said targeting data with respect to said organizational structure and wherein said plurality of choices includes at least a subset of said plurality of choices indicating probable solutions to said targeting data;
receiving from said remote user at least one selection from said plurality of choices;
iteratively applying the classifier to said targeting data and each said selection until a user target node is selected by the remote user.
